(19) United States
(12) Patent Application Publication
(10) Pub. No.: US 2011/0313595 A1
(43) Pub. Date: Dec. 22, 2011

(54) ELECTRONIC KEY

(75) Inventor: Hiroaki Kato, Kariya-shi (JP)

(73) Assignee: TOYOTA JIDOSHA KABUSHIKI KAISHA, Toyota-shi, Aichi-ken (JP)

(21) Appl. No.: 13/145,935

(22) PCT Filed: Mar. 15, 2010
(86) PCT No.: PCT/IB2010/000537

§ 371 Date: Jul. 22, 2011

(30) Foreign Application Priority Data
Mar. 16, 2009 (JP) 2009-063457

(51) Int. Cl. G06F 17/00

(52) U.S. Cl. 701/2

(57) ABSTRACT

An electronic key includes an electronic key body that executes a function to communicate with and control a controller for an on-board device to drive a device mounted on a vehicle, and a mechanical key that fits a cylinder lock provided on the vehicle. The electronic key body includes an accommodation portion that accommodates the mechanical key through insertion of the mechanical key, and a changeover device that changes over or restricts the function of the electronic key body. The mechanical key may be inserted into the accommodation portion in a first accommodation mode or a second accommodation mode, and the changeover device is operated only when the mechanical key is inserted in the accommodation portion in the second accommodation mode.

### FIELD OF THE INVENTION

The invention relates to an electronic key, and more specifically, to an electronic key used to remotely lock and unlock the doors of a vehicle.

### BACKGROUND OF THE INVENTION

In recent years, a passenger vehicle is often equipped with a so-called smart entry key system capable of locking/unlocking doors of the vehicle without using a mechanical key. The smart entry key system is mainly comprises a device mounted on the vehicle (hereinafter “on-board device” and “host vehicle” respectively) and an electronic key (hereinafter referred to as a “smart key”) carried by a user. When the user carrying the smart key, for example, approaches the host vehicle, the on-board device collates an ID code of the smart key. Then, when the on-board device confirms that the user is an authorized user of the host vehicle, the user can lock/unlock the doors of the host vehicle without using a mechanical key.

It should be noted that the on-board device and the smart key transmit/receive signals to thereby collate the ID code in the smart entry key system. More specifically, the on-board device transmits a request signal within a predetermined range. Further, the request signal is a signal for requesting the smart key to transmit an ID code.

When the user carrying the smart key approaches the host vehicle (enters the aforementioned predetermined range), the smart key receives the request signal transmitted by the on-board device. Upon receiving the request signal, the smart key transmits a response signal that includes an ID code to the on-board device. The on-board device receives the response signal and then determines whether the ID code included in the response signal matches a stored ID code registered in advance.

The smart key constantly performs a reception operation to transmit/receive the signals as mentioned above to/from the on-board device. Thus, a battery (cell) integrated with the smart key is gradually exhausted, and that the doors of the host vehicle cannot be locked/unlocked when the battery runs out. It should be noted that in such a case, the user replaces the battery of the smart key or inserts the mechanical key (hereinafter referred to as an emergency key) accommodated in a smart key body into a cylinder lock of the host vehicle to lock/unlock the doors.

For example, Japanese Patent Application Publication No. 2007-277927 (JP-A-2007-277927) discloses an art in which the function of a smart key is changed in accordance with whether an authenticated or an unauthenticated mechanical key is accommodated in the smart key.

More specifically, the art described JP-A-2007-277927 turns off the power supply of the smart key when an unauthenticated mechanical key (e.g., someone else's mechanical key) is accommodated in the smart key body. That is, the art described, in JP-A-2007-277927 enables the smart key functions only when the authenticated mechanical key is accommodated in the smart key.

However, the power supply of the smart key is constantly on to transmit/receive signals to/from the on-board device, and the smart key does not include a switch for turning the power supply off. Thus, when the smart key is not in use (i.e., when there is no need to transmit/receive signals to/from the on-board device), the power supply of the smart key is not turned off. Further, if the smart key includes a power supply switch, it becomes difficult to reduce the size of the smart key.

Further, the art described in JP-A-2007-277927 does not turn off the power supply of the smart key when the smart key is not in use. In other words, the function of the smart key may be restricted (the power supply of the smart key can be turned off) only if an unauthenticated, mechanical key is accommodated in the smart key body.

### SUMMARY OF THE INVENTION

The invention provides an electronic key (a smart key) capable of changing, with a simple construction, a function as the smart key by means of an authenticated mechanical key accommodated in an electronic key (smart key) body.

A first aspect of the invention relates to an electronic key. The electronic key includes an electronic key body that executes a function to communicate with and control a controller for an on-board device to drive a device mounted on a vehicle, and a mechanical key that fits a cylinder lock provided on the vehicle. The electronic key body includes an accommodation portion is formed in the electric key body to accommodate the mechanical key through insertion of the mechanical key, and a changeover device that changes over or restricts the function of the electronic key body. Further, the accommodation portion accommodates the mechanical key in a first accommodation mode or a second accommodation mode different from the first accommodation mode. The changeover device is operated only when the mechanical key is accommodated in the accommodation portion in the second accommodation mode.

In the above electronic key, the function of the electronic key can be changed over or restricted by simply changing the insertion orientation of the mechanical key with which the electronic key body is equipped. Accordingly, the electronic key (the smart key) whose function as the smart key can be changed by the authenticated mechanical key accommodated in the electronic key (smart key) body with a simple construction can be provided

The changeover device may open a power supply circuit in the electronic key body is equipped to disable the function of the electronic key body.

Depending on the accommodation mode of the mechanical key, the power supply circuit may be opened to disable the function of the electronic key body. That is, based on the accommodation mode of the mechanical key, the power supply of the electronic key can be turned on or off. Therefore, there is no need to provide a separate power supply switch in the electronic key body.

The changeover device may change an identification code which is assigned to the electronic key body, and which indicates whether the electronic key is an electronic key corresponding to the controller.

In the above-described electronic key, if, for example, there is a vehicle A that is equipped with an on-board device with an ID code A registered, in advance and a vehicle B equipped with an on-board device with an ID code B registered in advance, the same electronic key may be used for the two vehicles simply by changing the accommodation mode of the mechanical key.

The mechanical key may include a key plate and a shank, which serves as a handle of the mechanical key. The shank may be formed in a shape that is asymmetrical with respect to a longitudinally extending center line of the key plate.

The mechanical key may include a key plate and a shank, which serves as a handle of the mechanical key, and the shank may assume a shape that differs depending on whether the mechanical key is accommodated in the first accommodation mode or the second accommodation mode. when viewed from the electronic key body.

According to this electronic key, the difference between the first accommodation mode and the second accommodation mode can be recognized simply by taking a glance at the electronic key. Further, for example, a user can perceptually recognize the difference between accommodation of the mechanical key in the first accommodation mode and accommodation of the mechanical key in the second accommodation mode when holding the entire electronic key. Accordingly, there is no need to additionally provide means for indicating the difference between accommodation of the mechanical key in the first accommodation mode and accommodation of the mechanical key in the second accommodation mode.

The function of the electronic key body may be remote keyless entry.

The second accommodation mode may be realized by inverting the mechanical key accommodated in the first accommodation mode with respect to a longitudinal axis of symmetry of the key plate.

According to this electronic key, a changeover between the first accommodation mode and the second accommodation mode is made simply by inverting the mechanical key with respect to a line parallel to a direction in which the mechanical key is inserted into the accommodation portion. Therefore, the function of the electronic key body can be easily changed over or restricted.

The electronic key body may include an indicator that is identified from outside of the electronic key when the mechanical key is accommodated in the accommodation portion in the second accommodation mode.

The indicator may be designed to project beyond an edge of the electronic key body.

The electronic key body may further be equipped with a hooked member that turns so as to protrude outward from an edge of the electronic key body through abutment of a front end of the mechanical key on the hooked member when the mechanical key is accommodated in the accommodation portion in the second accommodation mode.

According to the electronic key described above, the difference between the first accommodation mode and the second accommodation mode can be recognized simply by taking a glance at the electronic key. Further, for example, the user can perceptually recognize the difference between accommodation of the mechanical key in the first accommodation mode and accommodation of the mechanical key in the second accommodation mode when holding the entire electronic key. Accordingly, there is no need to additionally provide means for indicating the difference between accommodation of the mechanical key in the first accommodation mode and accommodation of the mechanical key in the second accommodation mode.

A second aspect of the invention relates to a method of controlling an electronic key. In this case, the electronic key includes an electronic key body that executes a function to communicate with and control a controller for an on-board device to drive a device mounted on a vehicle, a mechanical key that fits a cylinder lock provided on the vehicle, and an accommodation portion that is formed in the electronic key body to accommodate the mechanical key. The method includes inserting the mechanical key in the accommodation portion in a first accommodation mode or a second accommodation mode; and executing an alternate function that is executed by the electronic key body when the mechanical key is inserted in the second accommodation mode.

### BRIEF DESCRIPTION OF THE DRAWINGS

The foregoing and further features and advantages of the invention will become apparent from the following description of example embodiments with reference to the accompanying drawings, wherein like numerals are used to represent like elements and wherein:

FIG. 1 is a block diagram showing the configuration of a smart entry key system including a smart key according to the embodiments of the invention;

FIG. 2 shows the internal structure of a smart key body and an emergency key according to the first embodiment of the invention;

FIG. 3 shows an example of an accommodation mode of the emergency key according to the first embodiment of the invention;

FIG 4 shows the internal structure of a smart key body and an emergency key according to the second embodiment of the invention; and

FIG. 5 shows an example of an accommodation mode of the emergency key according to the second embodiment of the invention.

### DETAILED DESCRIPTION OF THE EMBODIMENTS

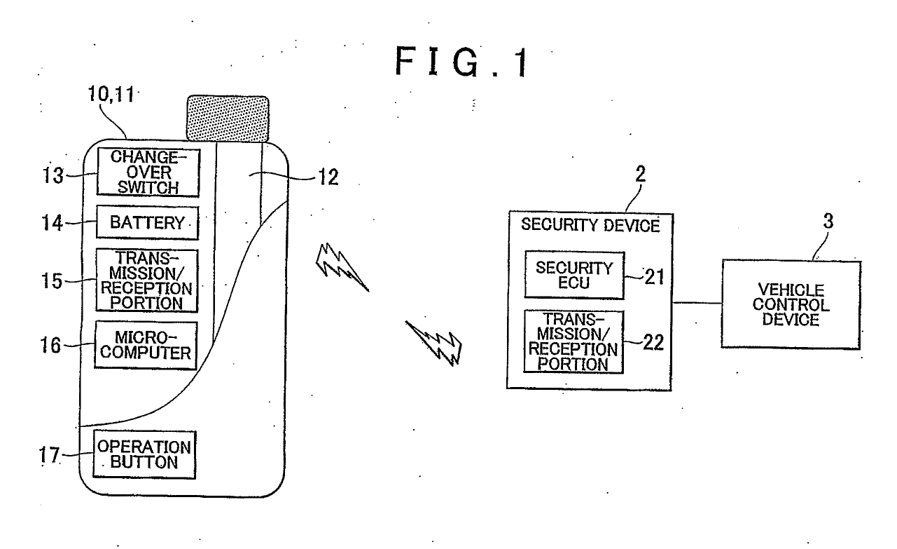

A electronic key (hereinafter “smart key”) 10 according to the first embodiment of the invention will be described hereinafter with reference to the drawings. FIG. 1 is a block diagram of the configuration of a smart entry key system that includes the smart key 10 according to this embodiment of the invention. It should be noted that in the following description, the smart entry key system is described in the context of use with a vehicle (e.g., a passenger vehicle which will be referred to hereinafter as an “host vehicle”).

In FIG. 1, the smart key 10 according to this embodiment of the invention is a smart key that is carried by a user of the host vehicle to, for example, lock/unlock doors of the host vehicle. In addition, the host vehicle may also be equipped with a security device 2 and a vehicle control device 3.

First, the outline of the smart key 10 according to this embodiment of the invention will be described.

The smart key which can remotely operate the locking/unlocking of the doors of the vehicle, is driven with a battery serving as a power supply. Further, the smart key 10 includes a mechanical key (hereinafter “emergency key”) that may be inserted into a cylinder lock of the host vehicle to lock/unlock the doors. The smart key 10 according to this embodiment of the invention may, for example, turn on/off the power supply of the smart key 10 in accordance with the accommodation mode of the emergency key within the smart key 10.

In FIG. 1, the smart key 10 is a smart key carried by the user of the host vehicle. The security device 2, mounted on the host vehicle, receives signals transmitted from the smart key 10 and issues a command to the vehicle control device 3 of the host vehicle. Further, the security device 2 is connected to the vehicle control device 3 of the host vehicle. It should be noted that the smart key 10 is equivalent to an example of the electronic key according to the invention.

First, the construction of the smart key 10 according to this embodiment of the invention will be described. As shown in FIG. 1, the smart key 10 according to this embodiment of the invention includes an emergency key 111, a changeover switch 13, a battery 14, a transceiver 15, a microcomputer 16, an operation button 17, and the like.

The emergency key 111 is a mechanical key that is inserted into a key cylinder of the host vehicle to lock/unlock the doors. It should be noted that the emergency key 111 is utilized, for example, when the battery 14 integrated with the smart key 10 is exhausted. Therefore, the emergency key 111 is accommodated in a body of the smart key 10. The emergency key 111 may be regarded as the mechanical key according to the invention.

The changeover switch 13 opens and closes an electric circuit (not shown) including the microcomputer 16, which is incorporated in the body of the smart key 10. Although the details of the changeover switch 13 will be described later, the changeover switch 13 is operated by the emergency key 111 when the emergency key 111 is inserted into the body of the smart key 10 in the appropriate orientation. It should be noted that the changeover switch 13 may be regarded as the changeover device according to the invention.

The battery 14 is a power supply for driving the transceiver 15 and the microcomputer 16. The battery 14 may be a primary battery such as a button type battery or the like, or a rechargeable secondary battery.

The transceiver 15 allows communication between the smart key 10 and the security device 2, and transmits an ID code assigned to the smart key 10 to a transceiver 22 of the security device 2. Further, the transceiver 15 receives a request signal transmitted by the security device 2, and transmits to the security device 2 a response signal to the request signal.

The microcomputer 16 includes memory in which the ID code assigned to the smart key 10 and the like are stored. For example, the microcomputer 16 transmits the ID code stored in the memory to the security device 2 via the transceiver 15. The security device 2 then authenticates the smart key 10 if the ID code registered in advance in the security device 2 corresponds with the ID code transmitted from the smart key 10. The microcomputer 16 of the smart key 10 may also transmit additional information, such as information regarding the remaining capacity of the battery 14 and the like to the security device 2.

The smart key 10 is carried by the user to, for example, lock/unlock the doors of the host vehicle. In general, therefore, an ID code that corresponds to the ID code registered in the on-board security device 2 provided in the host vehicle (hereinafter referred to as a corresponding ID code) is stored in the memory of the microcomputer 16 of the smart key 10.

Furthermore, an additional ID code may be stored in the memory of the microcomputer 16 of the smart key 10. The smart key 10 according to this embodiment may transmit the additional ID via the transceiver 15.

The operation button 17, when pressed, may operate various devices installed on the host vehicle. More specifically, after the security device 2 authenticates the smart key 10, the user of the host vehicle may press the operation button 17 to transmit a command signal from the transceiver 15 of the smart key 10 to the security device 2. The security device 2 then issues a command to the vehicle control device 3 of the host vehicle. In the smart entry key system, the locking/unlocking of the door locks of the host vehicle is a representative action resulting from the pressing of the operation button 17. That is, the user may remotely lock/unlock the door locks of the host vehicle by pressing the operation button 17.

The action executed when the operation button 17 is depressed is not limited to the locking/unlocking of the door locks of the host vehicle. For example, the smart entry key system may instead lock/unlock a luggage compartment door or open/close power sliding doors of the host vehicle when the operation button 17 is pressed. The function executed by pressing of the operation button 17 will be referred to hereinafter as a remote keyless entry (RKE) function.

Further, the locking/unlocking of the door locks of the host vehicle by the smart key 10 is not limited to the RKE function. For example, when a response signal transmitted to the security device 2 from the smart key 10 is authenticated by the security device 2, the security device 2 may, for example, lock/unlock the door locks. That is, when the user of the host vehicle possesses the smart key 10 corresponding to the host vehicle and approaches the host vehicle, the security device 2 may automatically, for example, lock/unlock the door locks. A function exerted without the user's operation (i.e., a function equivalent to the function resulting from the pressing of the operation button 17) will be referred to hereinafter as a smart function.

Next, the security device 2 mounted on the host vehicle will be described. It should be noted, as described above, that the security device 2 is connected to the vehicle control device 3 of the host vehicle.

As shown in FIG. 1, the security device 2 includes a security electronic control unit (ECU) 21, the transceiver 22, and the like.

The security ECU 21 includes at least an information processing circuit, such as, for example, a central processing unit (CPU) and a memory for storing data. The security ECU 21 authenticates the ID code transmitted by the transceiver 15 of the smart key 10 based on the ID code (the corresponding ID code) stored in the memory of the security ECU 21.

The transceiver 22 receives the signal including the ID code that is transmitted, by the transceiver 15 of the smart key 10. Further, the transceiver 22 may constantly or periodically send out a request signal within a predetermined distance.

If the security ECU 21 determines that authentication has been correctly carried out (i.e., when the ID code sent out by the smart key 10 coincides with the aforementioned corresponding ID code), various functions of the smart key 10 are enabled. For example, the security ECU 21 transmits a request signal to the smart key 10 via the transceiver 22 within a predetermined distance from the host vehicle. When the smart key 10 (the user possessing the smart key 10). enters the predetermined distance, it transmits a response signal to the security device 2.

In this case, when the smart key 10 has been authenticated, the security ECU 21 issues a command to the vehicle control device 3 to lock/unlock the doors of the host vehicle. Alternatively, the security ECU 21 may enable the function resulting from the pressing of the operation button 17 of the smart key 10 (the user presses the operation button 17 to lock/unlock the doors of the host vehicle).

The vehicle control device 3 is connected to the security device 2 and mounted on the host vehicle. More specifically, the vehicle control device 3, for example, releases electric door locks. of the host vehicle in accordance with a command from the security device 2.

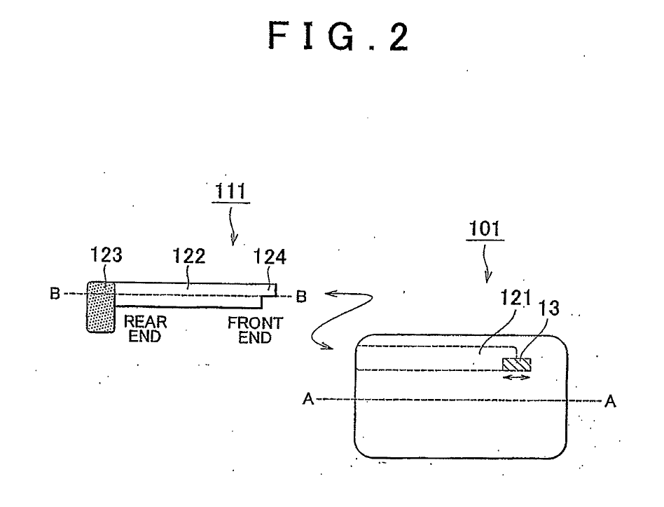

Next, the internal structure of the body of the smart key 10 and the emergency key 111 according to this embodiment of the invention will be described with reference to FIG. 2. It should be noted in the following description that the portion of the smart key 10 in which the emergency key 111 is accommodated (in other words, the portion of the smart key 10 that serves as a case of the emergency key 111) is referred to as a smart key body 101. That is, the assembly of the smart key body 101 and the emergency key 111 is referred to as the smart key 10. It should be noted that the smart key body 101 may be regarded as the smart key body according to the invention.

FIG. 2 shows the internal structure of the body of the smart key 10 and the emergency key 111 according to this embodiment of the invention. Further, FIG. 2 shows entire views of the smart key body 101 and the emergency key 111 for the sake of explanation. It should be noted that when the user carries the smart key 10, the emergency key 111 is usually accommodated in the smart key body 101. Then, for example, when the battery 14 runs out, the user removes the emergency key 111 from the smart key body 101, and inserts the emergency key 111 into the cylinder lock of the host vehicle to lock/unlock the doors.

The internal structure of the smart key body 101 will be described with reference to FIG. 2. As shown in FIG. 2, an emergency key accommodation portion 121 is provided within the smart key body 101. Further, the changeover switch 13 is provided at a distal end of the emergency key accommodation portion 121. It should be noted that a line extending through the centers of short sides of the smart key body 101 shown in FIG. 2 and parallel to long sides thereof is defined as broken lines A-A for the sake of explanation.

The emergency key accommodation portion 121 is a space provided within the smart key body 101 (the broken lines of FIG. 2) to accommodate the emergency key 111. The changeover switch 13 is slid by the emergency key 111 when the emergency key 111 is accommodated in the emergency key accommodation portion 121.

It should be noted that the changeover switch 13 slides in a direction parallel with the broken lines A-A as indicated by a bidirectional arrow in FIG. 2. More specifically, the changeover switch 13 is urged toward the entrance of the emergency key accommodation portion 121. That is, if the emergency key 111 is inserted in the emergency key accommodation portion 121, the changeover switch 13 at the distal end of the emergency key accommodation portion 121 is depressed. On the other hand, if the emergency key 111 is removed from the emergency key accommodation portion 121, the changeover switch 13 is released.

It should be noted that the battery 14, the transceiver 15, the microcomputer 16, as well as the emergency key accommodation portion 121 and the changeover switch 13 are provided inside the smart key body 101 as described above, but are not described or illustrated in the drawings.

In FIG, 2, the emergency key 111 will next be described. As shown in FIG. 2, the emergency key 111 includes a key plate portion 122 and a shank 123. A line extending past the center of the key plate portion 122 and parallel to long sides of the key plate portion 122 is defined as broken lines B-B in FIG. 2.

The key plate portion 122 is a mechanical key made of a metal or the like, has a key groove (not shown), and is inserted into the cylinder lock of the host vehicle to lock/unlock the doors. Further, the shank 123 (a grip held by the user when using the emergency key 111) is provided at the rear end of the key plate portion 122.

Further, as shown in FIG. 2, a region of a front end of the key plate portion 122 assumes a protrusive shape (the protrusive region of the front end will be referred to hereinafter as a protrusion 124). More specifically, as shown in FIG. 2, when the key plate portion 122 is divided along the broken lines B-B, one of the divided regions of the key plate portion 122 is longer than the other. That is, the front end of the key plate portion 122 is asymmetrically shaped with respect to the symmetry axis shown by the broken lines B-B.

It should be noted in the following description that the direction parallel to the broken lines A-A and broken lines B-B shown in FIG. 2 is referred to as a lateral direction, and that the direction perpendicular to the broken lines A-A and broken lines B-B shown in FIG. 2 is referred to as a longitudinal direction.

Further, the lateral width of the space of the emergency key accommodation portion 121 (the length in the direction parallel to the broken lines A-A provided inside the smart key body 101) is set in accordance with the lateral width of the key plate portion 122 (the length of the sides parallel to the broken tines B-B) such that the key plate portion 122 may fit within the emergency key accommodation portion 121.

However, as indicated by broken lines of FIG. 2, the shape of the emergency key accommodation portion 121 coincides with the shape of the key plate portion 122 when the key plate portion 122 is accommodated in the emergency key accommodation portion 121 in a predetermined orientation. In other words, a space is formed in the region of the emergency key accommodation portion 121 in which the protrusion 124 is fitted. That is, when the emergency key 111 shown in FIG. 2 is inverted along the broken lines B-B, the shape of the key plate portion 122 does not coincide with the shape of the emergency key accommodation portion 121. In this case, when the key plate portion 122 is inserted in the emergency key accommodation portion 121, the protrusion 124 abuts the changeover switch 13 at the distal end of the emergency key accommodation portion 121, thereby sliding and pressing the changeover switch 13.

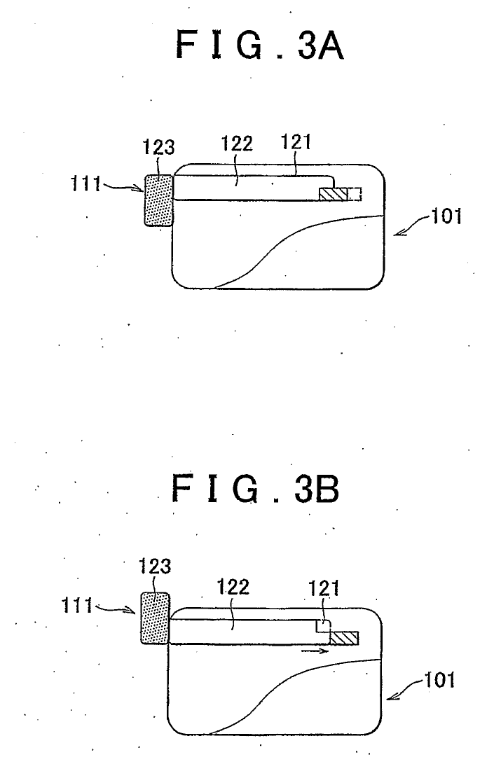

A more concrete description will be given hereinafter using a diagram of an internal structure of the smart key body 101 and the emergency key 111 shown in FIGS. 3A and 3B. FIG. 3A is a diagram showing an example in which the emergency key 111 is inserted in an orientation such that shape of the key plate portion 122 coincides with the shape of the emergency key accommodation portion 121. As shown in FIG. 3A, the emergency key 111 is inserted in an orientation where the shape of the key plate portion 122 coincides with the shape of the emergency key accommodation portion 121. Accordingly, the changeover switch 13 is not actuated by the protrusion 124 of the key plate portion 122 when the emergency key 111 is inserted.

On the other hand, FIG. 3B is a diagram showing an example in which the emergency key 111 shown in FIG. 2 is inverted along the broken lines B-B before being inserted into the emergency key accommodation portion 121. As shown in FIG. 3B, when the emergency key 111 is thus inserted, the shape of the key plate portion 122 does not coincide with the shape of the emergency key accommodation portion 121. Accordingly, the protrusion 124 abuts and actuates the changeover switch 13 into the distal end of the emergency key accommodation portion 121.

That is, the smart key 10 according to this embodiment of the invention is structured as described above, and hence can operate the changeover switch 13 (slide or refrain from sliding the changeover switch 13) in accordance with the accommodation mode in which the emergency key 111 is accommodated in the emergency key accommodation portion 121.

Further, as described above, the changeover switch 13 is designed to open or close the electric circuit that includes the microcomputer 16 incorporated in the body of the smart key 10. Thus, for example, in designing the smart key body 101, the changeover switch 13 may slide and turn the power supply of the smart key body 101 off (or turn power supply of the smart key body 101 on). In this design, the power supply of the smart key body 101 may. be turned on/off in accordance with the accommodation mode of the emergency key 111 the emergency key accommodation portion 121.

More specifically, the power supply of the smart key 10 is set to be turned off when the changeover switch 13 is depressed (FIG. 3B). In this manner, the power supply may be turned off simply by changing the accommodation mode of the smart key 10. That is, the emergency key 111 may be used as a switch for the smart key 10 without requiring the installation of a separate switch.

It should be noted that the changeover switch 13 is not limited in function to the turning on/off of the power supply of the smart key body 101. For example, the RKE function is set to be turned off when the changeover switch 13 is depressed. In this manner, the operation of the operation button 17 may be nullified simply by changing the accommodation mode of the emergency key 111. Alternatively, for example, the smart function is turned off when the changeover switch 13 is depressed. In this manner, the smart function may be turned off simply by changing the accommodation mode of the smart key 10.

Further, the function that is executed by pressing of the operation button 17 may be changed when the changeover switch 13 is depressed. For example, the default function of the operation button 17 may be set to operate the door locks of the host vehicle through the pressing of the operation button 17. However, when the changeover switch 13 slides, the electric circuit including the microcomputer 16 incorporated in the body, of the smart key 10 is closed. Then, when the user of the host vehicle presses the operation button 17, a command signal to open/close the doors (instead of locking/unlocking the door locks) is transmitted from the transceiver 15 of the smart key 10 to the security device 2. In this manner, the function itself executed by pressing the operation button 17 may be changed (the locking/unlocking of the door locks/the opening/closing of the doors) simply by changing the accommodation mode of the emergency key 111. As a result, the smart key 10 can be endowed with a variety of functions.

Furthermore, an ID code originally assigned to the smart key 10 (referred to as an ID code A) may be changed when the changeover switch 13 is depressed. The microcomputer 16 transmits, for example, a new ID code instead of the ID code originally assigned to the smart key 10 (hereinafter, the new ID code will be referred to as “ID code B”) via the transceiver 15, for example, when the changeover switch 13 slides. In this manner, if there are an host vehicle A, that is equipped with the security device 2 in which the ID rode A has been registered, and an host vehicle B (which is mounted with the security device 2 in which the ID code B is registered in advance), the host vehicle A and the host vehicle B may both be operated using the same smart key 10 simply by changing the accommodation mode of the emergency key 111.

That is, alternative functions of the smart entry key system may be enabled simply by changing the insertion orientation of the emergency key 111 in the smart key 10. Thus, eliminating the need to provide a separate changeover switch in the smart key 10 for selecting the alternate functions.

Further, the shank 123 of the emergency key 111 shown in FIG. 2 is positioned asymmetrically with respect to the symmetry axis indicated by the broken lines B-B. For example, the power supply of the smart key body 101 may be set on when the emergency key 111 is oriented as shown in FIG. 3A, and on the other hand, that the power supply of the smart key body 101 may be set off when the emergency key 111 is oriented as shown in FIG. 3B. As shown in FIG. 3B, the emergency key accommodation portion 121 is located above the broken lines (near an edge of the smart key body 101). Therefore, the shank 123 extends beyond the edge of the smart key body 101 when the power supply is off. Thus, the user can visually confirm that the power supply of the smart key body 101 is off.

Because the shank 123 of the emergency key 111 is positioned asymmetrically with respect to the symmetry axis indicated by the broken lines B-B the different orientations of the emergency key 111. shown in FIG. 3A and FIG. 3B may also be distinguished by feel. Thus, for example, if the smart key 10 is in a pocket, the user can determine whether the power supply of the smart key body 101 is off simply by touch. It should be noted that the internal structure of the smart key body 101 and the shape of the emergency key 111 as shown are merely examples. The emergency key accommodation portion 121 may be located at any suitable position and the shank 123 may be formed in any shape as long as a change in insertion orientation of the emergency key 111 is recognizable.

Next, a smart key 11 according to the second embodiment of the invention will be described. In the first embodiment of the invention, the changeover switch is pressed by the front end of the emergency key to slide the mechanical key (see FIG. 2). In the second embodiment of the invention, the changeover switch 13 is actuated perpendicularly to the direction in which the mechanical key is inserted via a hooked member.

It should be noted in this embodiment of the invention as well as the first embodiment of the invention that the description is given on the assumption that a smart entry key system including the smart key 11 according to the second embodiment of the invention is used for a vehicle.

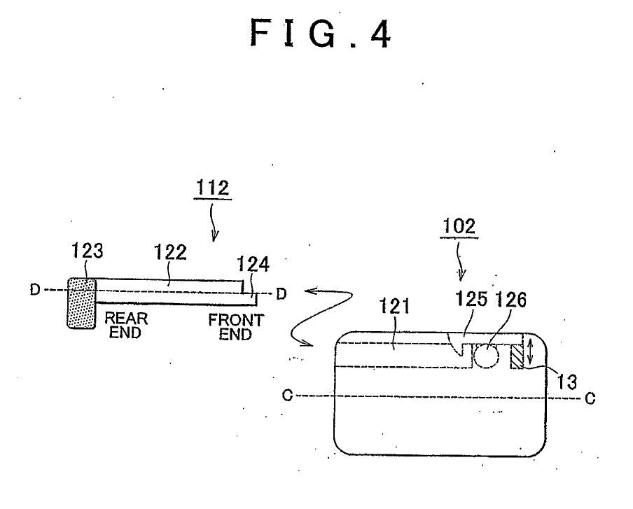

The internal structure of a body of the smart key 11 and an emergency key 112 according to the second embodiment of the invention will be described below with reference to FIG. 4.

FIG. 4 is a diagram showing the internal structure of the smart key body 102 and the emergency key 112 according to this embodiment of the invention.

As shown in FIG. 4, an emergency key accommodation portion 121, a hooked member 125, a turning shaft 126, and the changeover switch 13 are provided within the smart key body 102. It should be noted in this embodiment, as well as the first embodiment, that the battery 14, the transceiver 15, the microcomputer 16, and the like as well as the aforementioned components are provided inside the smart key body 101 but are not described or illustrated in the drawings. Further, for the sake of explanation, a line extending past the centers of short sides of the smart key body 102 shown in FIG. 4 and parallel to long sides thereof is defined as broken lines C-C.

The hooked member 125 may be an L-shaped member that is attached to the turning shaft 126 and Moves in the direction indicated by arrow of FIG. 4. Further, the hooked member 125 has a region extending perpendicularly from one end of the hooked member 125 in the direction of long sides. Then, when the protrusion 124 of the emergency key 112 abuts is pressed against the hook, the hooked member 125 turns around the turning shaft 126, and actuates, at the other end, the changeover switch 13 perpendicularly to the direction in which the emergency key 112 slides (perpendicularly to the broken lines C-C);

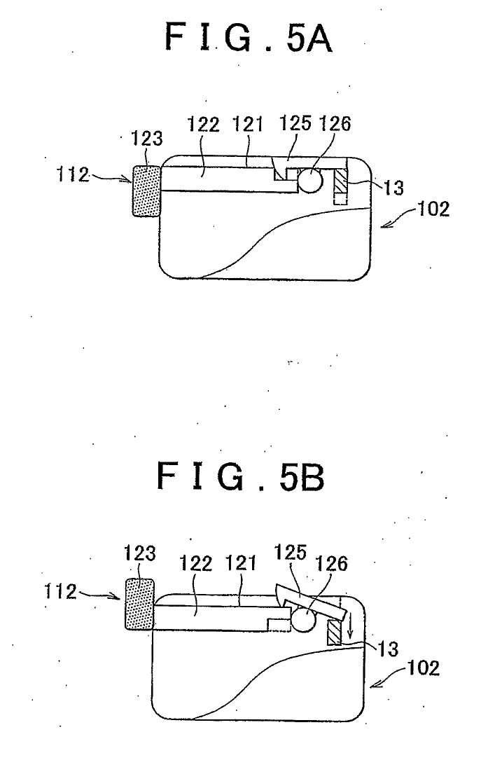

A more specific description will be given below using a diagram of the internal structure of the smart key body 102 and the emergency key 112 shown in FIGS. 5A and 5B. FIG. 5A shows an example in which the emergency key 112 is inserted in an orientation in which the protrusion 124 of the emergency key 112 does not abut on the hooked member 125. As shown in FIG. 5A, in this manner, the protrusion 124 of the emergency key 112 is located below the region of the hooked member 125 that extends perpendicularly from one end in the direction of the long sides thereof. Therefore, the emergency key 112 may be accommodated without causing actuation of the hooked member 125 by the protrusion 124.

However, FIG. 5B shows an example in which the emergency key 112 shown in FIG. 4 is inverted along broken lines D-D and inserted into the emergency key accommodation portion 121. As shown in FIG. 5B, in this manner, the front end of the protrusion 124 of the emergency key 112 abuts on a lateral face of that region of the hooked member 125, which extends perpendicularly from one end in the longitudinal direction thereof. That is, when the emergency key 112 is inserted in the emergency key accommodation portion 121, the front end of the protrusion 124 of the emergency key 112 abuts the region of the hooked member 125 and turns the hooked member 125 in the direction indicated by an arrow of FIG. 5B. In addition, the changeover switch 13 is the other end of the hooked member 125 simultaneously pushed downward.

As described above, the smart key 11 according to this embodiment of the invention operates the changeover switch 13 via the hooked member 125 in accordance with the accommodation mode of the emergency key 112 in the emergency key accommodation portion 121.

It should be noted in the first and second embodiments of the invention that the power supply of the smart key body 101 is turned off by sliding the changeover switch 13.

In addition, according to this embodiment of the invention, the emergency key accommodation portion 121 of the smart key 11 is located above the broken lines C-C of FIG. 4 (close to the edge of the smart key body 102). As shown in FIG. 5B, therefore, the hooked member 125 protrudes past the edge of the smart key body 102. Thus, the user may visually confirm that the power supply of the smart key body 102 is off.

It should be noted in both the first and second embodiments of the invention the shank 123 of the emergency key 112 assumes an asymmetrical shape with respect to the symmetry axis as depicted by the broken lines D-D. However, the invention is not restricted to this construction. That is, the shank 123 may assume any shape, as long as a change in the accommodation mode of the emergency key 112 is recognizable.

For example, if the user of the host vehicle is given two emergency keys (one of which is a spare key) that may be accommodated in the smart key body when the host-vehicle is purchased, the shank of one of the emergency keys may have a different shape. Further, the user may be given a dedicated emergency key used to slide the changeover switch.

As described above, according to the first and second embodiments of the invention, the series of the functions with which the smart key is endowed may be changed or restricted simply by changing the accommodation mode of the emergency key.

The smart key according to each embodiment of the invention may be utilized as an smart key that, for example, locks/unlocks the door locks of a vehicle and can change, with a simple construction, the function as the smart key even when the authenticated mechanical key is accommodated in the body of the smart key.

While the invention has been described with reference to the example embodiments thereof, it is to be understood that the invention is not limited to the described embodiments or constructions. To the contrary, the invention is intended to cover various modifications and equivalent arrangements. In addition, while the various elements of the disclosed invention are shown in various example combinations and configurations, other combinations and configurations, including more, less or only a single element, are also within the scope of the appended claims.

1. An electronic key comprising:
an electronic key body that executes a function to communicate with and control a controller for an on-board device to drive a device mounted on a vehicle; and
a mechanical key that fits a cylinder lock provided on the vehicle, wherein
an accommodation portion is formed in the electronic key body to accommodate the mechanical key through insertion of the mechanical key, wherein the accommodation portion is configured such that it can accommodate the mechanical key in a first accommodation mode and in a second accommodation mode different from the first accommodation mode, and wherein a changeover device of the electronic key body is configured to conduct at least one of changing over or restricting the function of the electronic key body,
the accommodation portion accommodates the mechanical key in the first accommodation mode or the second accommodation mode, and
the changeover device is operated only when the mechanical key key is accommodated in the accommodation portion in the second accommodation mode.

2. The electronic key according to claim 1, wherein the changeover device opens a power supply circuit which is equipped in the electronic key body to disable the function of the electronic key body.

3. The electronic key according to claim 1, wherein the changeover device changes an identification code which is assigned to the electronic key body, and which indicates whether the electronic key is an electronic key corresponding to the controller.

4. The electronic key according to claim 1, wherein
the mechanical key includes a key plate and a shank, which serves as a handle of the mechanical key, and
the shank is formed in a shape that is asymmetrical with respect to a longitudinally extending center line of the key plate.

5. The electronic key according to claim 1, wherein
the mechanical key includes a key plate and a shank, which serves as a handle of the mechanical key, and
the shank assumes a shape that differs depending on whether the mechanical key is accommodated in the first accommodation mode or the second accommodation mode when viewed from the electronic key body.

6. The electronic key according to claim 1, wherein the function of the electronic key body is remote keyless entry.

7. The electronic key according to claim 1, wherein the second accommodation mode is realized by inverting the mechanical key accommodated in the first accommodation mode with respect to a longitudinal axis of symmetry of the key plate.

8. The electronic key according to claim 1, wherein the electronic key body includes an indicator that is identified from outside of the electronic key when the mechanical key is accommodated in the accommodation portion in the second accommodation mode.

9. The electronic key according to claim 8, wherein the indicator is designed to project beyond an edge of the electronic key body.

10. The electronic key according to claim 1, wherein the electronic key body is further equipped with a hooked member that turns so as to protrude outward from an edge of the electronic key through abutment of a front end of the mechanical key on the hooked member when the mechanical key is accommodated in the accommodation portion in the second accommodation mode.

11. A method of controlling an electronic key that includes an electronic key body that executes a function to communicate with and control a controller for an on-board device to drive a device mounted on a vehicle, a mechanical key that fits a cylinder lock provided on the vehicle, and an accommodation portion that is formed in the electronic key body to accommodate the mechanical key, wherein the accommodation portion is configured such that it can accommodate the mechanical key in a first accommodation mode and in a second accommodation mode different from the first accommodation mode, the method comprising:
inserting the mechanical key in the accommodation portion in the first accommodation mode or the second accommodation mode; and
executing an alternate function that is executed by the electronic key body only when the mechanical key is inserted in the second accommodation mode.
